(19) United States
(12) Patent Application Publication
(10) Pub. No.: US 2019/0227494 A1
(43) Pub. Date: Jul. 25, 2019

(54) Screw-bezel Interchangeable Watch

(71) Applicant: Guofu ZHANG, Putian (CN)

(72) Inventor: Guofu ZHANG, Putian (CN)

(21) Appl. No.: 15/951,695

(22) Filed: Apr. 12, 2018

(30) Foreign Application Priority Data
Jan. 25, 2018 (CN) 201810072251.9

(51) Int. Cl. G04B 47/04; G04B 37/00; G04B 19/28

(52) U.S. Cl. CPC G04B 47/046; G04B 19/283; G04B 37/005

(57) ABSTRACT

The Invention relates to the technical field of watches, and in particular, to a screw-bezel interchangeable watch, comprising a watch case, a watch mechanical rotational apparatus, and an energy-supply knob. A watch bezel and the watch case are tightly threaded and movably connected. An upper end surface of the watch case has a circular structure. A transparent lens with a smaller diameter is provided in the middle of circular structure. An annular decorative ring is disposed on an outer side of the transparent lens, several decorative rings are disposed, and the decorative rings have different decorative effects.

### FIELD OF THE INVENTION

The Invention relates to the technical field of watches, and in particular, to a screw-bezel interchangeable watch.

### BACKGROUND OF THE INVENTION

Generally, a watch mainly includes components such as a movement, a case (comprising a watch glass and a bottom cover), a strap (made of metal or leather), a dial (made of copper, aluminum or paper), a rear cover (stainless steel), hands, and a crown. Currently, for watches in the prior art, a compression fastening manner is used in the design of a watch bezel, and a watch bezel the prior art cannot be detached and replaced at will. The service life and waterproof performance of watches are adversely affected once a watch bezel is detached or replaced. In such a fixing manner in existing watches, people cannot replace different bezels to change styles.

Nowadays consumers value personalization and fashion, and it is therefore a technical problem to be resolved by persons skilled in the art to design a screw-bezel interchangeable watch that manifests personality, novelty, and uniqueness. Bezels having different design styles can be replaced at will according to the preferences and different aesthetic requirements of consumers, so as to satisfy the fashion requirements of all consumer groups.

### SUMMARY OF THE INVENTION

The objective of the Invention is to provide a screw-bezel interchangeable watch, so as to resolve the technical problem in the prior art that a compression fastening manner is used in the design of a watch bezel, and a watch bezel cannot be detached and replaced at will, and as a result, people cannot replace different bezels to change styles.

To achieve the foregoing objectives, the following technical solutions are used in the Invention:

A screw-bezel interchangeable watch is designed, comprising a watch case, a watch mechanical rotational apparatus, and an energy-supply knob. The watch mechanical rotational apparatus is a member configured to implement hand rotation and indication of the watch, and is disposed inside the watch case. The energy-supply knob is disposed at a lateral end of the watch case, and is configured to manually provide working power to the watch mechanical rotational apparatus. The watch bezel is disposed on the watch case, inner threads are disposed on the watch bezel, and outer threads are disposed on the watch case. The watch bezel and the watch case are tightly threaded and movably connected. An upper end surface of the watch case has a circular structure. A transparent lens with a smaller diameter is provided in the middle of circular structure, and is configured to observe a degree of the watch mechanical rotational apparatus. The transparent lens is one of glass, ABS plastic, and mineral crystal. An annular decorative ring is disposed on an outer side of the transparent lens, several decorative rings are disposed, and the decorative rings have different decorative effects.

Preferably, at least one elastic clamping member is further disposed on the watch case, a clamping groove matching the elastic clamping member is disposed on the watch bezel, the elastic clamping member and the clamping groove are used to limit a rotational position of the watch bezel, the elastic clamping member is an elastic ball, a ball end of the elastic ball faces the watch bezel, the other end is fixed on the watch case, and the clamping groove is a circular groove matching the ball.

Preferably, the decorative ring has one of a layered structure and a three-dimensional structure.

Preferably, the energy-supply knob is connected to an energy storage member in the watch mechanical rotational apparatus.

The beneficial effects of the screw-bezel interchangeable watch provided in the Invention are as follows: (1). The apparatus in the Invention manifests novelty and uniqueness. A watch bezel of the watch is connected to a watch case through threads, and therefore detachment becomes convenient. Moreover, decorative rings having different colors are disposed on watch bezels, and consumers can purchase and replace watch bezels according to respective requirements. Therefore, the watch of the Invention satisfies fashion requirements of all consumer groups. (2). The apparatus of the Invention has a simple structure and can be conveniently detached, so that the appearance and style of the watch can be changed rapidly, conveniently, and inexpensively without affecting the structure and the service life of the watch.

### BRIEF DESCRIPTION OF THE DRAWINGS

The Invention is further described below in detail with reference to the embodiments in the drawings, but do not constitute any limitation to the Invention.

FIG. 1 is a schematic structural diagram of the apparatus according to the Invention; and

FIG. 2 is a schematic structural diagram of a watch bezel comprising decorative rings having different styles in the apparatus according to the Invention.

In the figures: Watch case 1; Watch mechanical rotational apparatus 2; Energy-supply knob 3; Watch bezel 4; and Transparent lens 5.

### DETAILED DESCRIPTION OF THE INVENTION

The technical solutions according to the embodiments of the Invention are clearly and thoroughly described with reference to the accompanying drawings in the embodiments of the Invention. Obviously, the described embodiments are merely exemplary ones, but are not all the embodiments of the Invention.

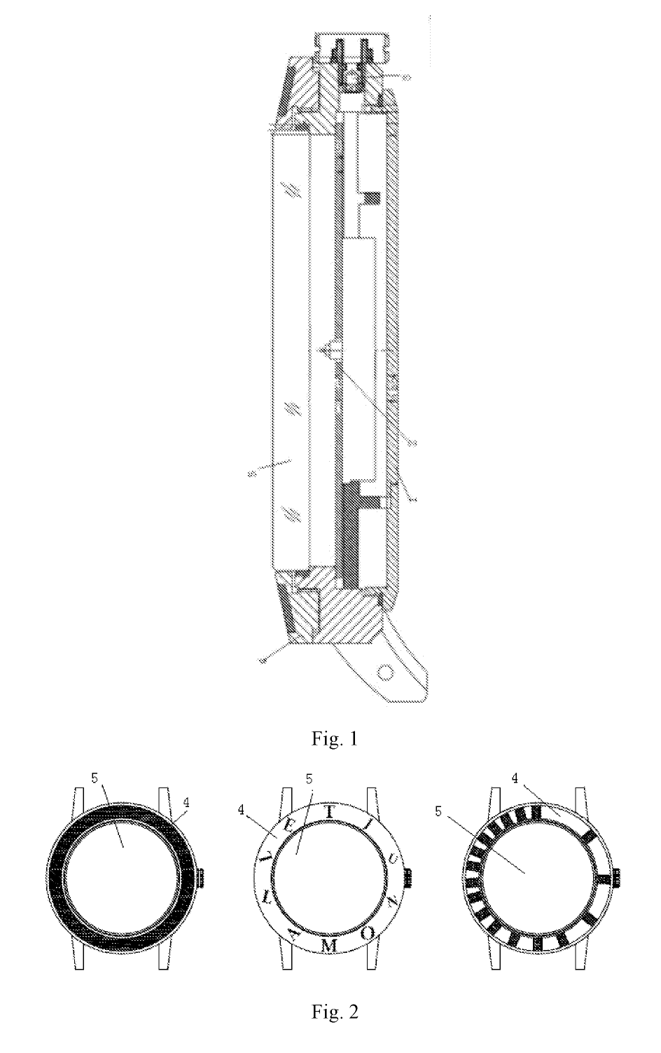

Referring to FIG. 1 and FIG. 2, a screw-bezel interchangeable watch comprises a watch case 1, a watch mechanical rotational apparatus 2, and an energy-supply knob 3. The watch mechanical rotational apparatus 2 is a member configured to implement hand rotation and indication of the watch, and is disposed inside the watch case 1. The energy-supply knob 3 is disposed at a lateral end of the watch case 1. The energy-supply knob 3 is connected to an energy storage member in the watch mechanical rotational apparatus 2, and is configured to manually provide working power to the watch mechanical rotational apparatus 2. A watch bezel 4 is disposed on the watch case 1. Inner threads are disposed on the watch bezel 4. Outer threads are disposed on the watch case 1. The watch bezel 4 and the watch case 1 are tightly threaded and movably connected. An upper end surface of the watch case 1 has a circular structure. A transparent lens 5 with a smaller diameter is provided in the middle of circular structure, and is configured to observe a degree of the watch mechanical rotational apparatus 2. The transparent lens 5 is one of glass, ABS plastic, and mineral crystal. An annular decorative ring is disposed on an outer side of the transparent lens 5, several decorative rings are disposed, and the decorative rings have different decorative effects. The decorative ring has one of a layered structure and a three-dimensional structure.

At least one elastic clamping member is further disposed on the watch case. A clamping groove matching the elastic clamping member is disposed on the watch bezel 4. The elastic clamping member and the clamping groove are used to limit a rotational position of the watch bezel. The elastic clamping member is an elastic ball, a ball end of the elastic ball faces the watch bezel 4, the other end is fixed on the watch case, and the clamping groove is a circular groove matching the ball.

The foregoing is merely preferred specific implementation manners of the Invention, but the protection scope of the Invention is not limited thereto. Equivalent replacements or changes made according to the technical solutions of the Invention and the inventive concept thereof by persons skilled in the art within the technical scope disclosed in the Invention shall all fall within the protection scope of the Invention.

1. A screw-bezel interchangeable watch, comprising a watch case (1), a watch mechanical rotational apparatus (2), and an energy-supply knob (3), wherein the watch mechanical rotational apparatus (2) is a member configured to implement hand rotation and indication of the watch, and is disposed inside the watch case (1), and the energy-supply knob (3) is disposed at a lateral end of the watch case (1), and is configured to manually provide working power to the watch mechanical rotational apparatus (2), characterized in that a watch bezel (4) is disposed on the watch case (1), inner threads are disposed on the watch bezel (4), outer threads are disposed on the watch case (1), and the watch bezel (4) and the watch case (1) are tightly threaded and movably connected; an upper end surface of the watch case (1) has a circular structure, a transparent lens (5) with a smaller diameter is provided in the middle of circular structure, and is configured to observe a degree of the watch mechanical rotational apparatus (2), and the transparent lens (5) is one of glass, ABS plastic, and mineral crystal; and an annular decorative ring is disposed on an outer side of the transparent lens (5), several decorative rings are disposed, and the decorative rings have different decorative effects.

2. The screw-bezel interchangeable watch according to claim 1, characterized in that at least one elastic clamping member is further disposed on the watch case, a clamping groove matching the elastic clamping member is disposed on the watch bezel (4), the elastic clamping member and the clamping groove are used to limit a rotational position of the watch bezel, the elastic clamping member is an elastic ball, a ball end of the elastic ball faces the watch bezel (4), the other end is fixed on the watch case, and the clamping groove is a circular groove matching the ball.

3. The screw-bezel interchangeable watch according to claim 1, characterized in that the decorative ring has one of a layered structure and a three-dimensional structure.

4. The screw-bezel interchangeable watch according to claim 1, characterized in that the energy-supply knob (3) is connected to an energy storage member in the watch mechanical rotational apparatus (2).
